(19) United States
(12) Patent Application Publication
(10) Pub. No.: US 2009/0219306 A1
(43) Pub. Date: Sep. 3, 2009

(54) LUMINANCE CORRECTION SYSTEM AND METHOD

(76) Inventors: Eun-Jung Oh, Suwon-si (KR); Dae-Kil Park, Suwon-si (KR)

Correspondence Address: CHRISTIE, PARKER & HALE, LLP, PO BOX 7068, PASADENA, CA, 91109-7068, US

(21) Appl. No.: 12/209,982

(22) Filed: Sep. 12, 2008

(30) Foreign Application Priority Data
Feb. 28, 2008 (KR) 10-2008-0018311

(51) Int. Cl. G09G 5/10

(52) U.S. Cl. 345/690

(57) ABSTRACT

A luminance correction system and method include: a data signal application module that applies a data signal to emit light at a maximum luminance; a luminance measurement module that measures luminance of a display region to which the data signal is applied; a comparator that compares luminance with a target value of luminance to obtain a difference value therebetween; a lookup table that adjusts luminance variations of R, G, and B pixels included in the display region by corresponding to the difference value; a data adjustment module that adjusts the data signal depending on the luminance variations of the R, G, and B pixels to transfer it to the data signal applying module; a color coordinate judgment module that judges a color coordinate of the display region; and a chroma correction module that controls chroma corresponding to the color coordinate judged by the color coordinate judgment module.

### CROSS-REFERENCE TO RELATED APPLICATIONS

This application claims priority of Korean Patent Application No.10-2008-0018311, filed on Feb. 28, 2008, in the Korean Intellectual Property Office, the entire content of which is incorporated herein by reference.

### BACKGROUND OF THE INVENTION

1. Field of the Invention

The present invention relates to a luminance correction system and method, and more particularly to a luminance correction system and method to reduce time required for luminance correction by using a stored lookup table.

2. Description of Related Art

An organic light emitting display displays an image using an organic light emitting diode (OLED) generating light by the recombination of an electron and a hole.

The organic light emitting diode includes an anode electrode, a cathode electrode, and a light emitting layer positioned therebetween. If current flows in a direction from the anode electrode to the cathode electrode, the organic light emitting diode emits light to represent colors.

The organic light emitting display as above has various advantages such as an excellent color representation, slimness, etc. so that it is widely used in a variety of applications, e.g., PDAs, MP3 players, display monitors, and TVs, in addition to cellular phones.

### SUMMARY OF THE INVENTION

The present invention is a luminance correction system and method capable of reducing manufacturing process time by reducing time to adjust white balance. According to a first aspect of the present invention, a luminance correction system includes: a data signal application module that applies a data signal to a display region to -emit light at a maximum luminance; a luminance measurement module that measures luminance of a pixel in the display region to which the data signal is applied; a comparator that compares the measured luminance with a target value of luminance to obtain a difference value therebetween; a memory storing a lookup table that includes luminance variations of R, G, and B pixels in the display region corresponding to the difference value; a data adjustment module that adjusts the data signal depending on the stored luminance variations of the R, G, and B pixels and transfers it to the data signal applying module; a color coordinate judgment module that judges a color coordinate of the of the R, G, and B pixels; and a chroma correction module that controls chroma corresponding to the color coordinate judged by the color coordinate judgment module.

According to a second aspect of the present invention, a luminance correction method includes: measuring luminance of a R, a G, and a B pixel emitting light at a maximum luminance; comparing the measured luminance with a target value of luminance to calculate the difference therebetween; judging luminance variations of each R, G. and B pixel corresponding to the calculated difference value; changing luminance of the R, G. and B pixels, depending on the judged luminance variations, and correcting chroma by selecting one of a plurality of cases of color coordinate of the R, G, and B pixels.

### BRIEF DESCRIPTION OF THE DRAWINGS

The accompanying drawings, together with the specification illustrate exemplary embodiments of the present invention, and, together with the description, serve to explain the principles of the present invention.

FIG. 1 is a block diagram of an organic light emitting display according to one embodiment of the present invention;

FIG. 2 is a block diagram of a luminance correction system according to one embodiment of the present invention;

FIG. 3 is a graph showing a color coordinate; and

FIG. 4 is a flow chart showing an exemplary luminance correction process, according to one embodiment of the present invention.

### DETAILED DESCRIPTION OF THE INVENTION

Hereinafter, certain exemplary embodiments according to the present invention will be described with reference to the accompany drawings. Herein, when a first element is described as being coupled to a second element, the first element may be not only be directly coupled to the second element but may also be indirectly coupled to the second element via a third element. Further, some of the elements that are not essential to the complete understanding of the invention are omitted for clarity. Also, like reference numerals refer to like elements throughout.

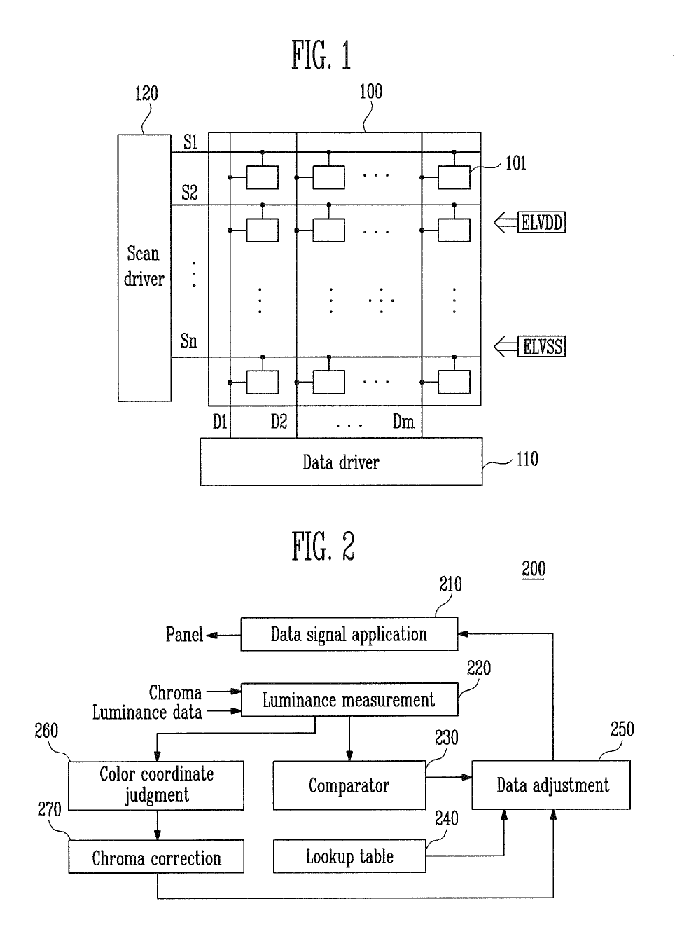

FIG. 1 is a block diagram of an organic light emitting display according to the present invention. Referring to FIG. 1, the organic light emitting display according to the present invention includes a display region 100, a data driver 110 and a scan driver 120.

The display region 100 includes a plurality of pixels 101 each of which includes an organic light emitting diode (not shown) emitting light corresponding to flow of current. Also, the display region 100 is arranged with a plurality of scan lines S1, S2, . . . Sn-1, and Sn formed in a row direction and transferring scan signals, and a plurality of data lines D1, D2, . . . , Dm-1, and Dm formed in a column direction for transferring data signals. Also, the display region 100 is driven by receiving first power ELVDD and second power ELVSS from external sources.

The data driver 110, which applies data signals to the display region 100, receives RGB video data having red, blue, and green components to generate data signals. Further, the data driver 110 applies the data signals generated by being coupled to the data lines D1, D2, . . . , Dm-1, and Dm to the display region 100.

The scan driver 120, which applies scan signals to the display region 100, is coupled to the scan lines S1, S2, . . . , Sn-1, and Sn to transfer the scan signals to a specific row of the display region 100. The pixel 101 transferred with the scan signals is transferred with the data signals output from the data driver 110 so that driving current is generated in the pixel 101 to be flown to the organic light emitting diode.

When measuring luminance of a completed product, the organic light emitting display constituted as above may display images at a maximum luminance lower than a target value due to a manufacturing process deviation. If the measurement value of luminance is different from the target value thereof, the product is judged as a defect. Therefore, a defect judgment should be avoided by compensating for the luminance as much as the difference between the measurement value and the target value. At this time, if only the luminance is raised, white balance may be broken due to efficiency difference of the respective R, G, and B pixels. Therefore, in order to solve such a problem, the color coordinate should also be corrected after correcting the luminance of the organic light emitting display.

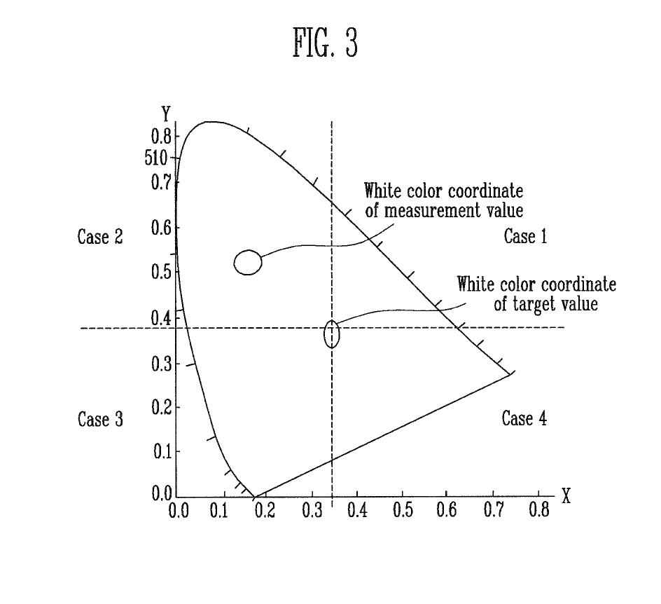

FIG. 2 is a block diagram of a luminance correction system according to the present invention. Referring to FIG. 2, the luminance correction system 200 includes a data signal application module 210, a luminance measurement module 220, a comparator 230, a lookup table 24, a data adjustment module 250, a color coordinate judgment module 260, and a chroma correction module 270.

The data signal application module 210 transfers a data signal which enables a display region 100 of the organic light emitting display to emit light at a maximum allowable luminance, to each pixel to enable the display region 100 to emit light at a maximum allowable luminance. In other words, if a gray scale of 255 is a maximum gray allowable scale, the data signal application module 210 transfers the data signal corresponding to 255 to each pixel 101.

The luminance measurement module 220 measures luminance and/or chroma of the display region 100 emitting light at a maximum luminance. If each pixel emits light at a maximum luminance, the organic light emitting display should ideally emit light in full white.

The comparator 230 compares a luminance value of the organic light emitting display measured in the luminance measurement module 220 with the target value of the luminance of the display region 100 to be corrected, and determines the difference between the measured luminance value and the target value. When the organic light emitting display emits light in full white (i.e., at a gray scale of 255), and the organic light emitting display is designed to have a luminance of 300 cd, the luminance target value thereof becomes 300 cd. At this time, if the measured luminance value is 270 cd, the difference judged in the comparator 230 becomes 30 cd.

The lookup table 24 stores luminance variations of the respective R, G, and B pixels corresponding to a difference between a measured luminance value and the target value. In other words, the lookup table 240 stores luminance variations of the respective R, G, and B pixels for a luminance change of 30 cd. The luminance change may be accomplished by controlling gamma values of the R, G, and B pixels. The luminance of the respective pixels can be numerically changed at the same time by using the luminance variations of the respective R, G, and B pixels stored in the lookup table 240, making it possible to reduce a luminance correction time.

In some embodiments, the lookup table 240 may be constituted as shown in the following table 1.

TABLE 1

| | R | G | B | |
|---|---|---|---|---|
| | Luminance | Luminance | Luminance | Luminance |
| | variations | variations | variations | variations |
| 1 | +3 | +3 | +3 | L (+3) |
| 2 | +2 | +2 | +2 | L (+2) |
| 3 | +1 | +1 | +1 | L (+1) |
| 4 | 0 | 0 | 0 | L (0) |
| 5 | −1 | −1 | −1 | L (−1) |
| 6 | −2 | −2 | −2 | L (−2) |
| 7 | −3 | −3 | −3 | L (−3) |

The data adjustment module 250 makes changes to the luminance of the R, G, and B pixels corresponding to the luminance variations of the R, G, and G pixels stored in the lookup table 240. In one embodiment, the data adjustment module 250 changes the luminance by converting the gamma values.

The data value to which the gamma value changed by the data adjustment module 250 is applied is transferred to the data signal application module 210. The data signal application module 210 transfers the data value is applied to the display region 100 of the organic light emitting display and thereby, allows the display region 100 to emit light corresponding to the data value to which the changed gamma value is applied. As a result, the display region 100 will have the target value of luminance.

The color coordinate judging module 260 judges a color coordinate of the display region 100 using the output of the luminance measurement module 220. When the luminance of the respective R, G, and B pixels is corrected, a color coordinate thereof varies, therefore, the white balance of the pixels may also be changed. To solve such a problem, the color coordinate judgment module 260 judges the color coordinate of the organic light emitting display.

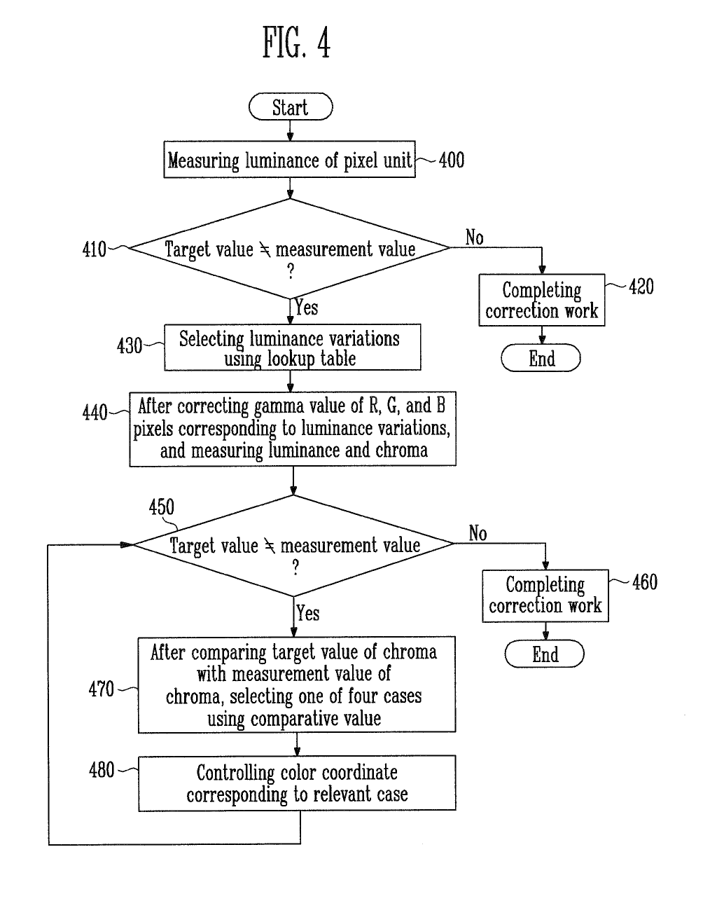

In some embodiments, the color coordinate judgment module 260 divides the color coordinate of the respective R, G, and B pixels into four cases (quadrants) depending on the measured white color coordinate, as shown in FIG. 3. In FIG. 3, the measured color coordinate of the display region 100 is shown to correspond to the second case.

The chroma correction module 270 corrects chroma according to cases judged in the color coordinate judgment module 260. A different correction of the chroma is then applied to the pixels depending on whether the luminance is high or low.

Table 2 shows a case where chroma is corrected in the chroma correction module 270.

TABLE 2

| | Case of high luminance | | | | Case of low luminance | | | |
|---|---|---|---|---|---|---|---|---|
| | case | case | case | case | case | case | case | case |
| | 1 | 2 | 3 | 4 | 1 | 2 | 3 | 4 |
| R | − | | | − | | + | + | |
| G | | − | | | | | | + |
| B | | | − | − | + | + | | |

Therefore, in the case of FIG. 3 (case 2), when the luminance of the display region 100 is higher than the target value thereof, the chroma correction module 270 lowers green chroma. When the luminance of the display region 100 is lower than the target value thereof, the chroma correction module 270 raises red chroma and blue chroma. Therefore, the control on the chroma is divided to and performed by a corresponding case, making it possible to reduce time to correct the chroma.

FIG. 4 is a flow chart showing an exemplary correcting luminance process .

Step 400: A data signal is applied to the organic light emitting display to cause the display to emit light at a maximum luminance, and then the luminance of a display region of the organic light emitting display is measured.

Step 410: The measured luminance and a target value of luminance are compared to determine the difference therebetween.

Step 420: If the measured luminance and the target value of luminance are identical or within a predetermined range, no correction is needed and the process ends. In one embodiment, such an instance of the difference value being identical or within a predetermined range is indicated in the lookup table, as no change (i.e., end the correction process).

Step 430: If the measured luminance and the preset target value of luminance are not identical or the difference is beyond a predetermined range, the luminance variations of the R, G, and B pixels are determined using the difference between the measured luminance and the target value of luminance. The luminance variations are determined using a lookup table, wherein the lookup table includes the luminance correction range of the R, G, and B pixels corresponding to the difference between the measured luminance and the target value of luminance. Also, if the difference between the measured luminance and the target value of luminance corresponds to an intermediate value of the luminance variations, higher luminance variations are selected.

Step 440: The luminances of the R, G, and B pixels are changed by applying the luminance correction range of the R, G, and B pixels. The luminances of the R, G, and B pixels are controlled by correcting a gamma value. Then, the luminance and chroma are observed.

Step 450: The measured values of the luminance and chroma are determined depending on the observed luminance and chroma and compared with the (preset) target value thereof.

Step 460: At this time, if the target value and the measurement value are identical or their difference is within a predetermined range, the correction work is completed.

Step 470: If the target value and the measurement value are not identical or their difference is beyond a predetermined range, it is determined which one of the four cases the measurement value of the chroma belongs.

Step 480: The color coordinate is controlled by corresponding to the relevant case and then step 450 is performed again.

With the luminance correction system and method according to the present invention, picture quality can be improved by adjusting white balance and the manufacturing process time can be reduced by reducing time to adjust the white balance.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A luminance correction system comprising:
a data signal application module that applies a data signal to a display region to emit light at a maximum luminance;
a luminance measurement module that measures luminance of a pixel in the display region to which the data signal is applied;
a comparator that compares the measured luminance with a target value of luminance to obtain a difference value therebetween;
a memory that stores a lookup table including luminance variations of R, G, and B pixels in the display region corresponding to the obtained difference value;
a data adjustment module that adjusts the data signal depending on the stored luminance variations of the R, G, and B pixels and transfers the data signal to the data signal application module;
a color coordinate judgment module that judges a color coordinate of the of the R, G, and B pixels; and
a chroma correction module that controls chroma of the R, G, and B pixels corresponding to the color coordinate judged by the color coordinate judgment module.

2. The luminance correction system as claimed in claim 1, wherein the data adjustment module changes a gamma value of the data signal to control the data signal.

3. The luminance correction system as claimed in claim 1, wherein the lookup table stores luminance variations of the R, G, and B pixels corresponding to an entire luminance variations.

4. The luminance correction system as claimed in claim 1, wherein the color coordinate judgment module divides a measured color coordinate into four quadrants and controls chroma of the R, G, and B pixels according to the divided color coordinate.

5. The luminance correction system as claimed in claim 4, wherein the chroma control of the R, G, and B pixels are differently applied depending on whether the measured luminance is higher or lower than the target value.

6. A method for correcting luminance comprising:
measuring luminance of a display region emitting light at a maximum luminance;
comparing the measured luminance with a target value of luminance to calculate a difference value therebetween;
judging luminance variations of a R pixel, a G pixel, and a B pixel corresponding to the calculated difference value;
changing luminance of the R, G, and B pixels depending on the judged luminance variations; and
correcting chroma by selecting one of a plurality of cases of color coordinate of the R, G, and B pixels.

7. The method as claimed in claim 6, wherein judging luminance variations of the respective R, G, and B pixels, utilizes a lookup table.

8. The method as claimed in claim 6, wherein changing the luminance is performed depending on the luminance variations of the respective R, G, and B pixels by adjusting a gamma value.

9. The method as claimed in claim 6, wherein correcting chroma is applied differently depending on whether the measured luminance is higher than the target value or the measured luminance is lower than the target value.

10. A method for correcting luminance in an organic light emitting display having a display region and a plurality of R, G, and B pixels, the method comprising:
applying data signals to cause the display region to emit light;
measuring luminance of the emitted light;
comparing the measured luminance to a target luminance value to determine a difference value;
accessing a lookup table using the difference value to determine luminance variations of a R pixel, a G pixel, and a B pixel in the display region;
changing luminance and chroma of the R, G, and B pixels depending on the determined luminance variations.

11. The method of claim 10 further comprising:
dividing color coordinate of the R, G, and B pixels into four quadrants depending on the measured white color coordinate of the R, G, and B pixels; and
correcting chroma of the R, G, and B pixels by selecting one of the four quadrants of color coordinate of the R, G, and B pixels.
